(19) United States
(12) Patent Application Publication
(10) Pub. No.: US 2026/0196038 A1
(43) Pub. Date: Jul. 9, 2026

(54) CLASSIFYING REGION VEGETATION USING VEGETATION INDEX SIGNATURE CURVES

(71) Applicant: Microsoft Technology Licensing, LLC, Redmond, WA (US)

(72) Inventors: Vaishnavi Nattar RANGANATHAN, Woodinville, WA (US); Peder Andreas OLSEN, Cortlandt Manor, NY (US); Bruno SILVA, Recife (BR); Angela BUSHESKA, Easton, PA (US)

(21) Appl. No.: 19/012,842

(22) Filed: Jan. 7, 2025

(51) Int. Cl. G06V 20/10; G06N 20/00; G06V 20/13

(52) U.S. Cl. CPC G06V 20/188; G06N 20/00; G06V 20/13

(57) ABSTRACT

A computerized method classifies vegetation in geographic regions. Target coordinates that describe a geographic region are obtained and vegetation data associated with the geographic region is obtained. In some examples, the vegetation data includes satellite imagery data of the geographic region. Vegetation index data points are generated using the obtained vegetation data (e.g., Normalized Difference Vegetation Index (NDVI) data points). A signature curve associated with the geographic region is plotted using the generated vegetation index data points and the vegetation in the geographic region is classified using the plotted signature curve. Then, a vegetation management action is caused to be performed in association with the geographic region based on the classified vegetation. The method enables the identification of crops in the geographic location and/or monitoring of forest growth or decline in the geographic location.

### BACKGROUND

Every year, 10 million hectares of forests are cleared which releases over 5.6 billion tons of greenhouse gases annually. This has prompted passage of the European Union Deforestation Regulation (EUDR), which aims to ensure that products linked to deforestation are excluded from the EU market. Satellite and remote sensing technologies can help implement such regulations globally, but these systems frequently misclassify vegetation types with similar visual characteristics.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for classifying vegetation in geographic regions is described. Target coordinates that describe a geographic region are obtained and vegetation data associated with the geographic region is obtained. In some examples, the vegetation data includes satellite imagery data of the geographic region. Vegetation index data points are generated using the obtained vegetation data (e.g., Normalized Difference Vegetation Index (NDVI) data points). A signature curve associated with the geographic region is plotted using the generated vegetation index data points and the vegetation in the geographic region is classified using the plotted signature curve. Then, a vegetation management action is caused to be performed in association with the geographic region based on the classified vegetation.

### BRIEF DESCRIPTION OF THE DRAWINGS

The present description will be better understood from the following detailed description read considering the accompanying drawings, wherein:

FIG. 1 is a block diagram of an example system configured to analyze vegetation signatures of geographic regions;

FIG. 2 is a flowchart illustrating an example method for analyzing a geographic region using vegetation index signature curve;

FIG. 3 is a flowchart illustrating an example method for plotting signature curves associated with geographic regions;

FIG. 4 is a flowchart illustrating an example method for analyzing NDVI data associated with a geographic region as defined by a set of selected coordinates;

FIG. 5 is a flowchart illustrating an example method for performing model analysis on NDVI data associated with a geographic region described by selected coordinates;

FIG. 6 is a flowchart illustrating an example method for comparing analysis results with CDL data;

FIG. 7 is a flowchart illustrating an example method for analyzing wildfire history data with respect to other analysis results;

FIG. 8 is a flowchart illustrating an example method for classifying vegetation in a region using a plotted signature curve and causing a vegetation management action to be performed based on the classified vegetation;

FIG. 9 is a diagram illustrating example GUIs for displaying information about a geographic region and associated vegetation classification; and

FIG. 10 illustrates an example computing apparatus as a functional block diagram.

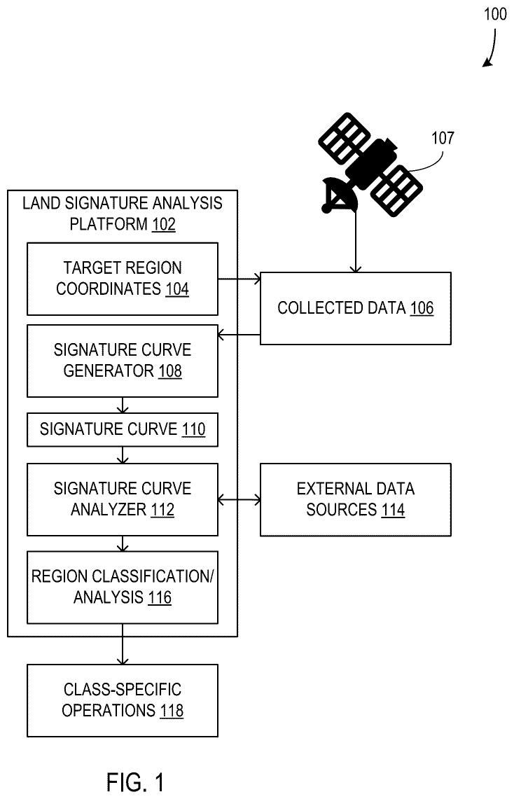

Corresponding reference characters indicate corresponding parts throughout the drawings. In FIGS. 1 to 10, the systems are illustrated as schematic drawings. The drawings may not be to scale. Any of the figures may be combined into a single example or embodiment.

### DETAILED DESCRIPTION

Aspects of the disclosure provide systems and methods for determining the vegetation in a geographic region as well as determining characteristics about that vegetation, such as the volume of the vegetation present. Further, in some examples, the described systems and methods enable the performance of vegetation management actions in response to the classification of vegetation in the geographic region. Input coordinates are used to determine the geographic region to be analyzed and vegetation data associated with the geographic region is obtained. In some examples, the vegetation data includes satellite imagery data such as near infrared light image data. The vegetation data is used to calculate vegetation index data points for the geographic region and the vegetation index data points are plotted to form a signature curve for the geographic region. The signature curve is then used to classify the vegetation in the geographic region (e.g., through comparison to ground truth signature curves and/or using a trained machine learning (ML) model for classifying vegetation). Vegetation management actions are initiated or otherwise caused to be performed based on the classification of the vegetation in the geographic region. Such actions can include monitoring changes in forest borders, forest thickness, irrigation, and/or fertilization of farm crops.

The disclosure operates in an unconventional manner at least by using the described vegetation index signature curves for vegetation classification. By generating vegetation index data points using a vegetation index that is indicative of vegetation characteristics that change as plants grow, specific patterns of growth in a geographic region are observable using consistently gathered satellite imagery data. Plotting those patterns as signature curves associated with the geographic regions being analyzed provides visual patterns that can be compared efficiently by humans and/or by trained ML models. Using the described techniques to classify vegetation provides improved accuracy over other satellite-based systems. Further, in some examples, the use of trained ML models for analyzing signature curves and related data and classifying vegetation provides improved computing system resource efficiency, such as more efficient use of processing and memory resources.

Aspects of the disclosure include a temporal signature mapping system that combines spectral vegetation indices, satellite imagery and cropland data layer (CDL) data to measure historical land use. Temporal variables and agricultural practices like crop rotations and growth cycles of plants are visible in satellite-based spectral index data. In some examples, the system determines and/or uses yearly vegetation patterns in the form of normalized difference vegetation index (NDVI) signatures, based on plant photosynthesis, to distinguish wild forests from crops. In many cases, the NDVI signatures are unique to different crops and follow consistent patterns throughout the world. It should be understood that, in other examples, other indices are used as the vegetation index, such as land surface temperature band, green index layer, irrigation probability, and/or evaporative fraction layer. Further, in some examples, multiple vegetation indices are used in combination.

Further, in some examples, the disclosed methods include analyzing yearly NDVI change on various farms and/or with various unique crops. Signature curves are verified as being consistent with agricultural practices, such that the signature curves can be used to distinguish between unique crops and forests.

The NDVI metric is a remote sensing vegetation indicator. Molecules such as chlorophyll in live green plants have higher absorption for specific wavelengths of light (e.g., 400-500 nm, 600-700 nm) while longer near infrared (NIR) light not used in photosynthesis are reflected by the leaf cell structure to prevent overheating. NDVI is calculated as a ratio of spectral reflectance measurements in the NIR and visible red bands as illustrated in equation 1 below:

$$NDVI = \frac{NIR - Red}{NIR + Red} \qquad ( 1 )$$

It has been determined that NDVI values vary uniquely over time based on growth cycles of specific vegetation and farming practices. To compute this unique signature curve, satellite imagery data (e.g., Sentinel-2 imagery from GOOGLE EARTH Engine (GEE), planetary computers, or FARMVIBES.AI), is pre-processed to remove those images with a cloud mask ratio over 10%. Next, daily NDVI values are computed (e.g., at a 10-meter resolution) for the target region and dates. The raw NDVI is shifted to be positive to exclude bare soil or clouds. Additionally, the NDVI data is normalized to a 0-1 scale to enable consistent analysis across datasets. The signature curves for specific types of vegetation appear to be consistent globally, due to the similarity in growing cycles.

To support applications such as land use tracking and vegetation health, aspects of the disclosure develop a longitudinal NDVI dataset using satellite imagery data (e.g., Sentinel-2 data). To support small farms, a sub-kilometer grid scale of 500×500 m is selected. This, however, results in a large quantity of locations when used at scale, each of which requires multi-year time series data. To facilitate the resulting large datasets, the current region is divided into multiple subregions. Each subregion is divided into a 0.25 km² grid and the procedure described herein is followed to extract cloudless data, in some examples.

The date range is filtered to capture the full growing cycles of various crops and show vegetation dynamics. The NDVI is calculated using satellite imagery data from the filtered date range. The first large dataset collected and processed in this way provides a time series of vegetation health determined for each location and serves as the foundational input for generating signature curves for further analysis.

Additionally, in some examples, the described systems and methods include an end-to-end artificial intelligence (AI) powered land use analysis platform that is used to combine insights about NDVI signatures with other data sets. An example land use analysis platform takes as input a set of geographic coordinates that define the target region. From the dataset, the platform filters coordinates within this geo-polygon by coarse latitude and longitude ranges to identify the dataset region. Next, the platform calculates the Euclidean distance between a target coordinate and points in the satellite imagery dataset. The platform extracts the corresponding signature curves within the prescribed polygon, for example by computing the mean NDVI value per time point across valid coordinates. The platform then interpolates the NDVI values and fits a third order polynomial. In some examples, the platform presents users with a graphical user interface (GUI) that plots the region using an interactive map library (e.g., the Leaflet interactive map library) which creates an interface to adjust the geographic polygon and plot the NDVI signature curve.

Further, in some examples, the platform also analyzes the data to extract land use insights. The platform checks that the data is valid and that the curve has more than a threshold of data points (e.g., 10 points) for robust classification. The platform extracts features such as the annual minimum and maximum NDVI, range, and median. The platform determines the growth and decline rates by calculating the maximum point difference in NDVI values. These metrics are used to check if the curve is an annual crop. In some examples, this means that the NDVI increases above 0.2 indicating healthy vegetation growth, reaches a peak between 0.2 and 0.8, and is followed by a decline. The platform checks that the growth and decline rates are greater than 0.005 to filter out perennial species which only have small NDVI fluctuations across seasons. In other examples, other patterns are used to identify/classify a crop without departing from the description.

In some examples, the platform complements these metrics with an analysis based on a generative AI model (e.g., including a language model such as a large language model (LLM)). Statistics associated with the NDVI data and/or other data are provided to the model. For instance, in an example, such data includes maximum, minimum and average NDVI values, an image of the NDVI curve, and a classification of whether the region contains vegetation using a JavaScript object notation (JSON) format. Vegetation presence can be determined using thresholds. For instance, in an example, values of less than 0.1 are non-vegetative, 0.1-0.2 represents some vegetation, and 0.2 represents healthy vegetation. In some examples, images passed into the model are converted to grayscale, resized, and encoded as a base64 string within the JSON. Prompts are constructed to query the model such as the following: “The area of interest is defined by [coordinates]. Please analyze the land cover type at this location.”

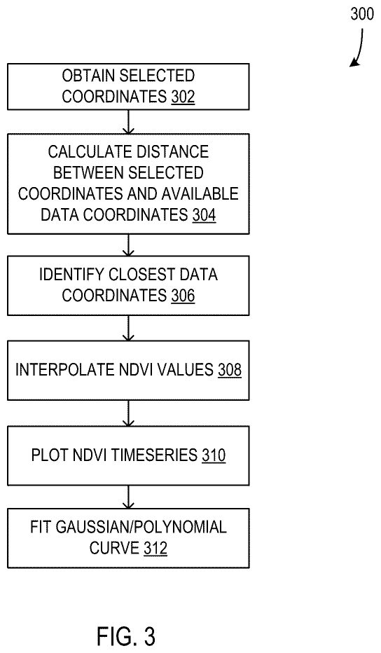

Aspects of the disclosure include using a model such as Generative Pre-training Transformer 4 (GPT-4) which translates the curves and data into a detailed analysis table, providing an additional validation. Further explanation of the operations is presented in FIG. 3.

FIG. 1 is a block diagram of an example system 100 configured to analyze vegetation signatures of geographic regions. In some examples, the signature analysis platform 102 uses target region coordinates 104 of a geographic region to collect or otherwise access collected data 106 associated with those target region coordinates 104. The collected data 106 is provided as input to the signature curve generator 108, which is configured to generate a signature curve 110 associated with the geographic region. The signature curve 110 is used by the signature curve analyzer 112 to generate region classification/analysis output 116. In some examples, the signature curve analyzer 112 also uses data from external data sources 114 as input in the generation of the region classification/analysis output 116. In response to the region classification/analysis output 116, one or more class-specific operations 118 are performed in association with the geographic region targeted by the target region coordinates 104.

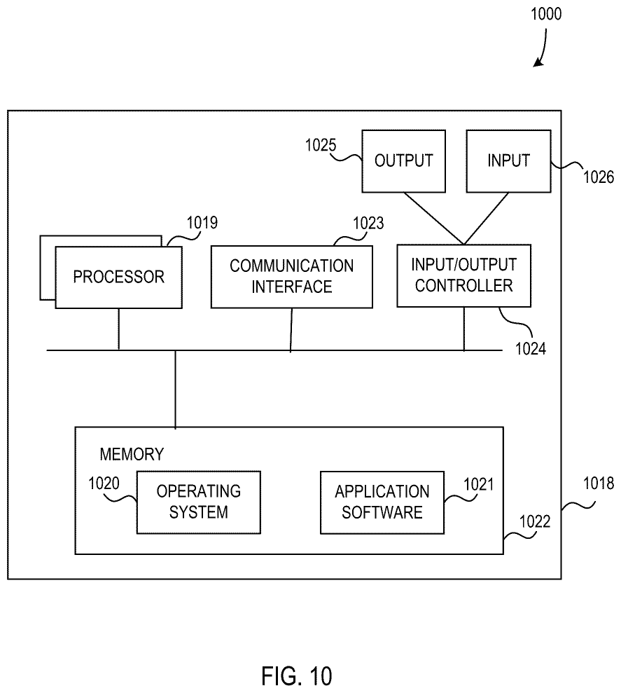

Further, in some examples, the system 100 includes one or more computing devices (e.g., the computing apparatus of FIG. 10) that are configured to communicate with each other via one or more communication networks (e.g., an intranet, the Internet, a cellular network, other wireless network, other wired network, or the like). In some examples, entities of the system 100 are configured to be distributed between multiple computing devices and to communicate with each other via network connections. For example, the signature analysis platform 102 is executed on a first computing device and the collected data 106 is located on a second computing device within the system 100. The first computing device and second computing device are configured to communicate with each other via network connections. Alternatively, in some examples, other components of the signature analysis platform 102 (e.g., the signature curve generator 108 and the signature curve analyzer 112) are executed on separate computing devices and those separate computing devices are configured to communicate with each other via network connections during the operation of the signature analysis platform 102. In other examples, other organizations of computing devices are used to implement system 100 without departing from the description.

In some examples, the target region coordinates 104 are indicative of a geographic region for which vegetation data 106 has been collected. In some examples, the collected vegetation data 106 includes satellite imagery data as collected by satellites 107 as described herein. Additionally, in some examples, the collected data 106 includes vegetation data from a series of time intervals (e.g., one satellite image per day over period of 200 days).

The signature curve generator 108 includes hardware, firmware, and/or software configured to generate a signature curve 110 from collected data 106 such as satellite imagery data that is indicative of vegetation presence and/or growth in a geographic region. In some examples, the generated signature curve 110 is a curve that describes data value associated with geographic region over a period of time. For instance, in an example, the signature curve generator 108 is configured to calculate a vegetation index data value (e.g., NDVI values) for the geographic region for each time interval (e.g., each day). The calculated vegetation index data values are then graphed in association with the period of time to form the signature curve 110.

The signature curve analyzer 112 includes hardware, firmware, and/or software configured to perform analysis operations on the signature curve 110 and/or data from other external data sources 114 in order to classify vegetation at the target region coordinates 104 and/or otherwise draw conclusions about the state of the vegetation at the target region coordinates 104. In some examples, the signature curve analyzer 112 includes a trained AI/ML model that has been trained to classify vegetation in a geographic region based on the signature curve 110 and/or other input. The classification of the vegetation is included in the region classification/analysis output 116. Additionally, or alternatively, the region classification/analysis output 116 includes other data, such as predicted growth rate or spread of vegetation in the geographic region, estimated likelihood that fire will affect the vegetation in the geographic region, indications of the need for fertilizer, water, or other treatment for the vegetation in the geographic region, or the like.

In some examples, external data sources 114 include data from the CDL and/or wildfire historical data. In other examples, other types of external data sources 114 are used without departing from the description.

In some examples, the signature analysis platform 102 provides the region classification/analysis 116 for use in performance of class-specific operations 118. In some examples, the classification of the vegetation indicates that the geographic region includes a specific type of crop vegetation. Based on identifying the type of crop vegetation, the signature analysis platform 102 is configured to trigger the performance of one or more operations 118 specific to that type of crop vegetation (e.g., performance of watering, fertilization, or the like on a schedule that is, at least in part, specific to the type of crop vegetation, the location of the crop vegetation, predicted weather in the geographic location, or the like). Alternatively, in some examples, the classification of the vegetation indicates that the geographic region includes a type of forest. Based on identifying the presence and type of the forest, the triggered class-specific operations 118 include forest fire monitoring operations, determination of the degree to which the forest is growing or shrinking, or the like. In other examples, other types of class-specific operations 118 are triggered by the signature analysis platform 102 without departing from the description.

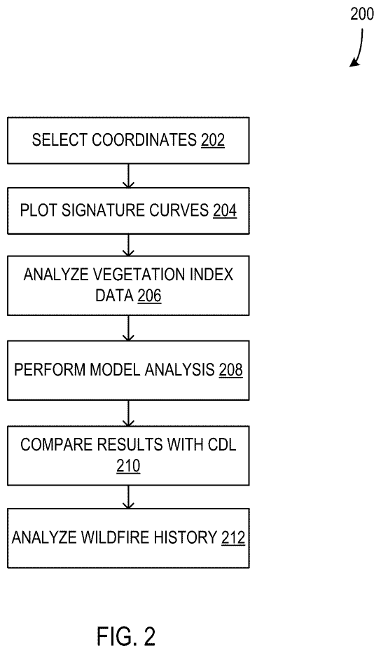

FIG. 2 is a flowchart illustrating an example method 200 for analyzing a geographic region using vegetation index signature curve. In some examples, the method 200 is executed or otherwise performed by or in association with a system such as system 100 of FIG. 1.

At 202, the geographic coordinates are selected. In some examples, the selection of the coordinates is performed based on information received from a user of the system. Alternatively, or additionally, the coordinates are automatically selected based on an automated computer process (e.g., a process that is configured to analyze multiple sets of coordinates in series or in parallel). Further, in some examples, the selected geographic coordinates are associated with specific geographic regions that are to be analyzed.

At 204, signature curves associated with the selected coordinates are plotted. In some examples, the plotting of the signature curves is performed as described in method 300 of FIG. 3. Further, in some examples, the signature curves include sets of vegetation index values plotted with time on a graph, such that the vegetation index is represented on one axis and time is represented on the other axis. The relationships between the vegetation index values and time at which the data was collected are then described using the plotted signature curves.

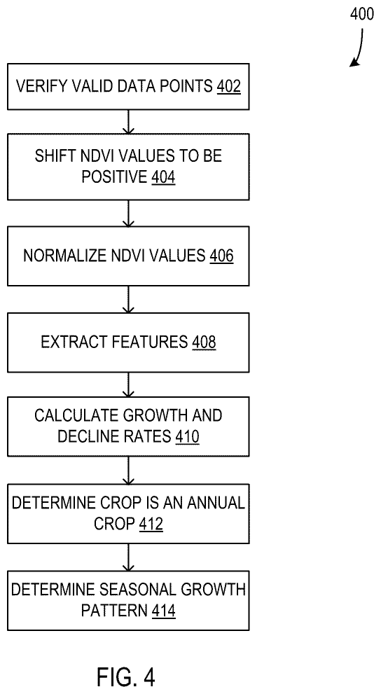

At 206, the vegetation index data is analyzed. In some examples, the analysis of the vegetation index data is performed as described in method 400 of FIG. 4.

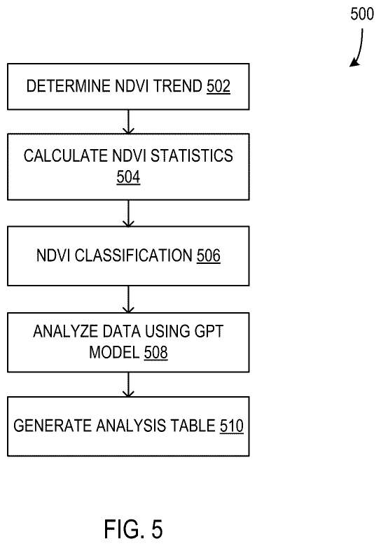

At 208, model analysis is performed. In some examples, the model analysis is performed as described in method 500 of FIG. 5.

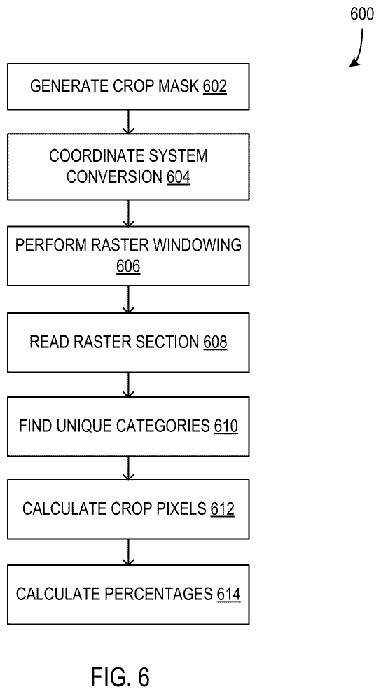

At 210, the results of the above analyses are compared with the CDL or other vegetation data source. In some examples, the comparison with the CDL is performed as described in method 600 of FIG. 6.

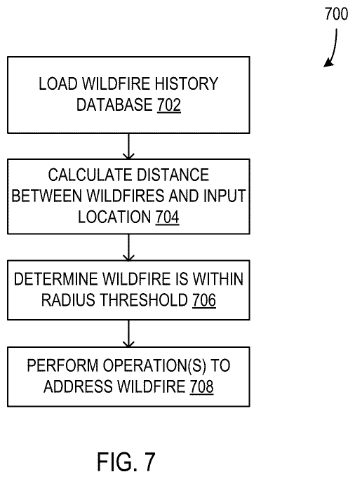

At 212, wildfire history data is analyzed with respect to the selected coordinates and/or results of the above analyses. In some examples, the analysis of the wildfire history data is performed as described in method 700 of FIG. 7.

FIG. 3 is a flowchart illustrating an example method 300 for plotting signature curves associated with geographic regions. In some examples, the method 300 is performed as part of method 200 of FIG. 2 and/or in association with a system such as system 100 of FIG. 1.

At 302, selected coordinates are obtained. In some examples, the selected coordinates describe a geographic region that is to be analyzed.

At 304, the distances between the selected coordinates and the set of coordinates for which data has been collected are calculated and, at 306, the closest coordinates for which data has been collected (e.g., “data set coordinates”) are identified. In some examples, the coordinates for which data has been collected are limited and the selected coordinates to be analyzed do not precisely match that set of coordinates. By calculating the distances between the selected coordinates and the data set coordinates and determining the closest data set coordinates to the selected coordinates, an accurate analysis of the region associated with the selected coordinates can be performed.

At 308, NDVI values are interpolated with respect to the identified closest data set coordinates and, at 310, an associated NDVI timeseries is plotted. In some examples, average NDVI values associated with all the identified closest data set coordinates are used to plot a single NDVI timeseries that represents the target region. At 312, a curve is fitted to the plotted NDVI timeseries to form the signature curve associated with the selected coordinates. In some examples, the fitted curve is a Gaussian curve or a polynomial curve. In other examples, other types of curve fitting can be used without departing from the description.

It should be understood that, while the above description of method 300 describes the use of NDVI as the vegetation index, in other examples, other vegetation indices are used without departing from the description.

In some examples, the time series signature for the entire region is determined, which is useful in uniform areas such as single farms. Alternatively, or additionally, in some examples, signatures are computed for each pixel in the region and mean curve is obtained with the deviation around the mean for better insights. The subsequent mean and/or median analysis is also performed at the pixel level. These options are used in specific non-homogeneous land profile cases.

FIG. 4 is a flowchart illustrating an example method 400 for analyzing NDVI data associated with a geographic region as defined by a set of selected coordinates. In some examples, the method 400 is performed as part of method 200 of FIG. 2 and/or in association with a system such as system 100 of FIG. 1.

At 402, the valid data points are verified. In some examples, the verification of the valid data points includes ensuring that there are enough valid data points for classification and/or other aspects of the analysis.

At 404, the NDVI values are shifted in such a way as to cause all the NDVI values to be positive. For instance, in an example, a most negative NDVI value is identified from the set of NDVI values and all NDVI values are increased by an amount that causes the most negative NDVI value to be greater than or equal to zero. Then, at 406, the NDVI values are normalized to a scale from zero to one.

At 408, features are extracted from the normalized NDVI values. In some examples, the extracted features include the maximum NDVI value, the minimum NDVI value, the range of the NDVI values, and/or the median NDVI value. In other examples, other features are extracted without departing from the description.

At 410, the growth rate and/or decline rate of the NDVI values are calculated.

At 412, the method 400 determines whether the vegetation being analyzed is an annual crop. In some examples, the determination includes comparing the extracted features, growth rate, and/or decline rate to defined ranges and/or thresholds that are indicative of annual crops. For instance, in an example, if the NDVI range is greater than 0.2, the peak time value is between 0.2 and 0.8, the growth rate is greater than 0.005, and the decline rate is less than −0.005, the vegetation being analyzed is considered to be an annual crop. In other examples, other ranges and/or thresholds are used without departing from the description.

At 414, the method 400 determines the seasonal growth pattern of perennial vegetation. In some examples, this seasonal growth pattern is represented as a curve on a graph associated with a time period spanning multiple seasons.

In some examples, the results generated from the method 400 are used in other portions of the described process (e.g., the results are provided to the model as input during the model analysis subprocess).

It should be understood that, while the above description of method 400 describes the use of NDVI as the vegetation index, in other examples, other vegetation indices are used without departing from the description.

FIG. 5 is a flowchart illustrating an example method 500 for performing model analysis on NDVI data associated with a geographic region described by selected coordinates. In some examples, the method 500 is performed as part of the method 200 of FIG. 2 and/or in association with a system such as system 100 of FIG. 1.

At 502, an NDVI trend is determined and, at 504, NDVI statistics are calculated (e.g., maximum NDVI, minimum NDVI, and/or average NDVI). In some examples, the extracted features from method 400 above are used as statistics in method 500.

At 506, an NDVI classification is performed. In some examples, the NDVI classification includes comparing NDVI values to defined thresholds and/or ranges. For instance, in an example, the analyzed region is considered to be non-vegetative if the NDVI value is less than −0.1, the region is considered to include some vegetation if the NDVI value is between zero and 0.2, and the region is considered to include healthy vegetation if the NDVI value is greater than 0.2. In other examples, other thresholds and/or ranges are used without departing from the description.

At 508, the data is analyzed using a GPT model. In some examples, the analysis results generated in the above methods are used as input to the GPT model. For instance, in some examples, images of signature curves are provided as input. Additionally, or alternatively, other data is provided as input, including determined trend data, calculated NDVI statistics, and/or the NDVI classification from 506. In other examples, other types of ML models are used without departing from the description.

At 510, as a result of the analysis by the GPT model, an analysis table is generated. In some examples, the analysis table is generated to include statistical data, data features, and/or other data associated with the geographic region (e.g., peak time, median NDVI, growth rate, decline rate, vegetation indicators, annual crop indicators, and/or perennial vegetation indicators).

It should be understood that, while the above description of method 500 describes the use of NDVI as the vegetation index, in other examples, other vegetation indices are used without departing from the description.

FIG. 6 is a flowchart illustrating an example method 600 for comparing analysis results with CDL data. In some examples, the method 600 is performed as part of the method 200 of FIG. 2 and/or in association with a system such as system 100 of FIG. 1.

At 602, a crop mask associated with the geographic region is generated. In some examples, the crop mask includes a binary array of crop categories, with each entry of the array being associated with a specific crop category. The entries are binary flag values such that if an entry includes a one, the crop mask includes the crop category with which that entry is associated and if an entry includes a zero, the crop mask does not include the crop category with which the entry is associated.

At 604, the coordinate system is converted to match a raster system (e.g., from geodetic coordinate system EPSG: 4326 to the raster system) and then, at 606, raster windowing is performed with respect to the converted coordinates.

At 608, a raster section within a polygon is read and, at 610, unique crop categories are identified in the read raster section. At 612, the crop pixels of the raster section are counted and, at 614, percentages of crops in the counted crop pixels are calculated. As a result, percentages of different types of crops in the raster section are determined (e.g., 40% corn, 50% wheat, 10% other).

FIG. 7 is a flowchart illustrating an example method 700 for analyzing wildfire history data with respect to other analysis results. In some examples, the method 700 is performed as part of the method 200 of FIG. 2 and/or in association with a system such as system 100 of FIG. 1.

At 702, data from a wildfire history database is loaded and, at 704, distances between wildfires as indicated in the data of the wildfire history database and an input location (e.g., the geographic region being analyzed) are calculated. At 706, it is determined that one or more wildfires are within a radius threshold of the input location and, at 708, in response to the determination at 706, operations are performed to address the wildfire(s) (e.g., trigger alarms or notifications at the input location, activate sprinklers or other automated anti-fire mechanisms at the input location, etc.).

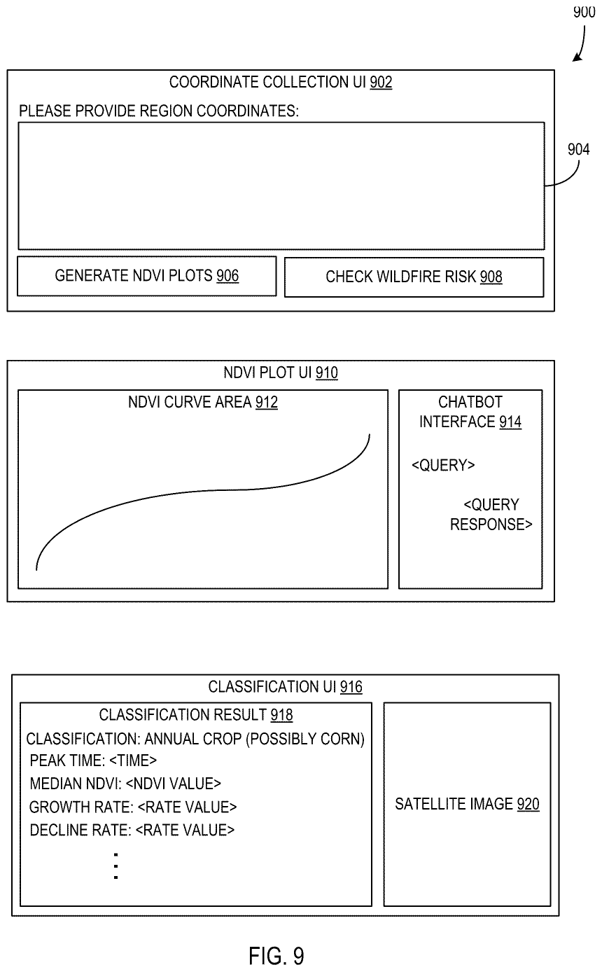

In some examples, the method 700 is performed based on input provided to a GUI such as the coordinate collection UI 902 of FIG. 9. Coordinates that describe the target geographic region are provided via the GUI and a wildfire risk button 908 or other similar GUI component is activated. The method 700 then operates as described above. In some such examples, operations performed to address the wildfires include displaying a wildfire alert on the GUI, including location information, wildfire size information, wildfire containment information, wildfire datetime information, or the like. Further, in some examples, the method 700 enables users to view historical wildfire information about wildfires that have previously occurred in or near the target geographic region.

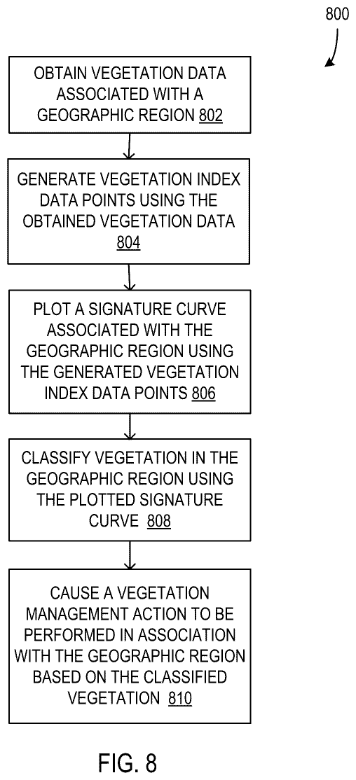

FIG. 8 is a flowchart illustrating an example method 800 for classifying vegetation in a region using a plotted signature curve and causing a vegetation management action to be performed based on the classified vegetation. In some examples, the method 800 is performed in association with a system such as system 100 of FIG. 1.

At 802, vegetation data associated with a geographic region is obtained. In some examples, the vegetation data includes satellite imagery data (e.g., visible light imagery, near infrared imagery, or the like). Further, in some examples, the method 800 includes obtaining coordinates associated with the geographic region prior to obtaining the vegetation data. Additionally, or alternatively, in some examples, the vegetation data includes other data associated with the geographic region, such as historical record data, sensor data, or the like.

At 804, vegetation index data points are generated using the obtained vegetation data. In some examples, the vegetation index data points include NDVI data points. Alternatively, or additionally, in other examples, other vegetation indices are used without departing from the description. Further, in some examples, generating the vegetation index data points includes generating data points associated with multiple instances in time during a time period with which the vegetation data is associated. Additionally, generating the vegetation index data points includes generating data points associated with different locations within the geographic region, such that there are multiple vegetation index data points associated with the geographic region for a specific instance in time.

Further, in some examples, the generation of the vegetation index data points includes averaging or otherwise combining vegetation index data points associated with different locations in the geographic region to generate an average or otherwise combined set of vegetation index data points. For instance, in an example, generating the vegetation index data points includes identifying a set of coordinates for which the vegetation data exists, wherein the identified set of coordinates is representative of the geographic region. Vegetation index data points associated with the set of coordinates are calculated using the obtained vegetation data and average vegetation index data points are generated using the calculated vegetation index data points associated with the set of coordinates.

At 806, a signature curve associated with the geographic region is plotted using the generated vegetation index data points. In some examples, the signature curve is plotted with the vegetation index data point values on a y-axis and time on an x-axis of a graph, such that the change in vegetation index data point value over time is represented by the signature curve. Thus, the curve can be plotted to represent the growth and/or decline of vegetation in the geographic region over time.

At 808, the vegetation in the geographic region is classified using the plotted signature curve. In some examples, the plotted signature curve is compared to a set of ground truth signature curves associated with different types of vegetation. The ground truth signature curve that is most similar to the plotted signature curve provides the most likely type of vegetation in the geographic region. Additionally, or alternatively, the plotted signature curve is provided as input to an ML model trained for classifying vegetation. The ML model is then used to generate the vegetation classification.

Further, in some examples, other data is used with the signature curve, such as data values from the raw vegetation data and/or statistical feature values extracted from the vegetation data. In some such examples, this other data is also provided to the ML model for use in generating the vegetation classification.

At 810, a vegetation management action is caused to be performed in association with the geographic region based on the classified vegetation. In some examples, the vegetation management action includes updating a GUI to display the vegetation classification and/or data associated therewith. Additionally, or alternatively, in some examples, the vegetation management action includes generating a notification indicating that a forest fire is in close proximity to the geographic region, triggering a crop watering operation to be performed in the geographic region, triggering a crop fertilizing operation to be performed in the geographic region, or the like.

In some examples, the method 800 includes further analysis of the geographic region based on other data sources, such as the CDL and/or a wildfire historical data set. The classification of the vegetation in the geographic region is based at least in part on the analysis of the geographic region based on those other data sources.

FIG. 9 is a diagram illustrating example GUIs 900 for displaying information about a geographic region and associated vegetation classification. In some examples, the GUIs 900 are executed or otherwise performed in association with a method such as method 800 of FIG. 1 and/or in association with a system such as system 100 of FIG. 1.

The GUIs 900 include a coordinate collection UI 902. The coordinate collection UI 902 includes a section 904 configured to enable a user to enter coordinates that will be used to determine the geographic region for analysis. In some examples, a user is enabled to type or otherwise enter coordinates in the section 904. Alternatively, or additionally, the section 904 is configured to display a map, and users are enabled to place or otherwise select a region on the displayed map to select the coordinates.

The coordinate collection UI 902 includes a Generate NDVI Plots button 906 and a Check Wildfire Risk button 908. In some examples, the button 906 is configured to cause the NDVI Plot UI 910 to be displayed as described herein. The button 908 is configured to cause an analysis of wildfire historical data with respect to the selected coordinates, resulting in an indicator of wildfire risk of the selected coordinates being provided to the user.

The NDVI Plot UI 910 is configured to display and/or enable interaction with an NDVI signature curve associated with a geographic region (e.g., the region defined by the selected coordinates from the coordinate collection UI 902). The NDVI Plot UI 910 includes an NDVI Curve Area 912 configured to display a generated signature curve associated with the selected coordinates. Additionally, the NDVI Plot UI 910 includes a Chatbot Interface 914. In some examples, the Chatbot Interface 914 enables the user to send queries to a chatbot that is powered by a trained language model. The chatbot responds to queries with query responses specific to the plotted NDVI curve and/or other information about the area described by the selected coordinates.

The GUIs 900 include a classification UI 916 that is configured to display classification results associated with vegetation in the region described by the selected coordinates. A classification result section 918 displays or otherwise provides a classification of the vegetation (e.g., “annual crop (possibly corn)”) and/or other statistical data values that are associated with its classification. As illustrated, some statistical values include peak time, median NDVI, growth rate, and decline rate. In other examples, other values are displayed in the classification result 918 without departing from the description. Further, the classification UI 916 includes a satellite image section 920 that is configured to display a satellite image of the region described by the selected coordinates. In some examples, the satellite image 920 includes labels and/or color coding that is indicative of the vegetation classification of the region. Additionally, or alternatively, other data is displayed on the satellite image 920 in association with the vegetation classification of the region.

### Additional Examples

In an example, vegetation in a region is classified as being wild forest. The vegetation management action performed includes triggering a process for monitoring the boundaries of the forested region over time. As changes occur in the boundary of the forested region, those changes are logged and/or notifications associated with the changes are triggered, enabling users of the system to respond to such changes. For instance, detecting substantial changes in the boundaries of the forested region may indicate that the region is being illegally logged. Alternatively, such boundary changes may be indicative of an outbreak of disease amongst the forest trees. Such events may merit a response by a user who is notified by the system.

In another example, an initial data set of signature curves is generated for a wide range of geographic regions. Those signature curves are combined with existing data from the CDL or other similar database, enabling those initial signature curves to be associated with the crops or other vegetation that are currently growing in the geographic regions. After those associations are made, a ground truth signature curve data set has been created that can then be used to classify future signature curves.

In another example, the described systems and methods are used to maintain up-to-date crop classification in fields across a wide range of geographic regions. Data obtained through this classification and monitoring of crop growth and/or crop decline is then used to enable tracking and traceability of foods grown in the fields, food supply chain optimization, data sharing, prediction of food availability and more.

### Exemplary Operating Environment

The present disclosure is operable with a computing apparatus according to an embodiment as a functional block diagram 1000 in FIG. 10. In an example, components of a computing apparatus 1018 are implemented as a part of an electronic device according to one or more embodiments described in this specification. The computing apparatus 1018 comprises one or more processors 1019 which may be microprocessors, controllers, or any other suitable type of processors for processing computer executable instructions to control the operation of the electronic device. Alternatively, or in addition, the processor 1019 is any technology capable of executing logic or instructions, such as a hard-coded machine. In some examples, platform software comprising an operating system 1020 or any other suitable platform software is provided on the apparatus 1018 to enable application software 1021 to be executed on the device. In some examples, classifying vegetation in a region using satellite-based vegetation index signature curves as described herein is accomplished by software, hardware, and/or firmware.

In some examples, computer executable instructions are provided using any computer-readable media that is accessible by the computing apparatus 1018. Computer-readable media include, for example, computer storage media such as a memory 1022 and communications media. Computer storage media, such as a memory 1022, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1022) is shown within the computing apparatus 1018, it will be appreciated by a person skilled in the art, that, in some examples, the storage is distributed or located remotely and accessed via a network or other communication link (e.g., using a communication interface 1023).

Further, in some examples, the computing apparatus 1018 comprises an input/output controller 1024 configured to output information to one or more output devices 1025, for example a display or a speaker, which are separate from or integral to the electronic device. Additionally, or alternatively, the input/output controller 1024 is configured to receive and process an input from one or more input devices 1026, for example, a keyboard, a microphone, or a touchpad. In one example, the output device 1025 also acts as the input device. An example of such a device is a touch sensitive display. The input/output controller 1024 may also output data to devices other than the output device, e.g., a locally connected printing device. In some examples, a user provides input to the input device(s) 1026 and/or receives output from the output device(s) 1025.

The functionality described herein can be performed, at least in part, by one or more hardware logic components. According to an embodiment, the computing apparatus 1018 is configured by the program code when executed by the processor 1019 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain target coordinates; obtain vegetation image data associated with a geographic region described by the obtained target coordinates; generate vegetation index data points using the obtained vegetation image data; plot a signature curve associated with the geographic region using the generated vegetation index data points; classify vegetation in the geographic region as a forest using the plotted signature curve; and cause a forest preservation action to be performed in association with the geographic region based on the vegetation being classified as a forest.

An example computerized method comprises obtaining vegetation data associated with a geographic region; generating vegetation index data points using the obtained vegetation data; plotting a signature curve associated with the geographic region using the generated vegetation index data points; classifying vegetation in the geographic region using the plotted signature curve; and causing a vegetation management action to be performed in association with the geographic region based on the classified vegetation.

One or more computer storage media having computer-executable instructions that, upon execution by a processor, case the processor to at least: obtain vegetation data associated with a geographic region, wherein the vegetation data includes satellite imagery data of the geographic region, including near infrared light data; generate vegetation index data points using the obtained vegetation data; plot a signature curve associated with the geographic region using the generated vegetation index data points; compare the plotted signature curve to ground truth signature curves; classify vegetation in the geographic region based on the comparison of the plotted signature curve to the ground truth signature curves; and cause a vegetation management action to be performed in association with the geographic region based on the classified vegetation.

Alternatively, or in addition to the other examples described herein, examples include any combination of the following:
wherein obtaining the vegetation data associated with the geographic region includes obtaining satellite imagery data of the geographic region, including near infrared light data.
wherein generating the vegetation index data points using the obtained vegetation data includes generating Normalized Difference Vegetation Index (NDVI) data points.
wherein generating vegetation index data points using the obtained vegetation data includes: identifying a set of coordinates for which obtained vegetation data exists, wherein the identified set of coordinates is representative of the geographic region; calculating vegetation index data points associated with the set of coordinates using the obtained vegetation data, wherein vegetation index data points are calculated for each coordinate in the set of coordinates over a time period; and generating average vegetation index data points using the calculated vegetation index data points associated with the set of coordinates; and wherein plotting the signature curve associated with the geographic region using the generated vegetation index data points includes plotting the signature curve using the generated average vegetation index data points.
wherein classifying vegetation in the geographic region using the plotted signature curve includes: providing the plotted signature curve to a trained model as input; generating a model query requesting classification of vegetation in the geographic region; and generating, by the trained model, vegetation classification output in response to the generated model query.
further comprising analyzing the obtained vegetation data using at least one of a cropland data layer (CDL) data set or a wildfire historical data set, wherein classifying the vegetation in the geographic region and causing the vegetation management action to be performed are based on analyzing the obtained vegetation data.
wherein the vegetation management action includes at least one of the following: generating a notification indicating that a forest fire is in close proximity to the geographic region, triggering a crop watering operation to be performed in the geographic region, triggering a crop fertilizing operation to be performed in the geographic region, or displaying a graphical user interface (GUI) of the geographic region including an indication of a vegetation type within the geographic region.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining vegetation data associated with a geographic region; exemplary means for generating vegetation index data points using the obtained vegetation data; exemplary means for plotting a signature curve associated with the geographic region using the generated vegetation index data points; exemplary means for classifying vegetation in the geographic region using the plotted signature curve; and exemplary means for causing a vegetation management action to be performed in association with the geographic region based on the classified vegetation.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
obtain target coordinates;
obtain vegetation image data associated with a geographic region described by the obtained target coordinates;
generate vegetation index data points using the obtained vegetation image data;
plot a signature curve associated with the geographic region using the generated vegetation index data points;
classify vegetation in the geographic region as a forest using the plotted signature curve; and
cause a forest preservation action to be performed in association with the geographic region based on the vegetation being classified as a forest.

2. The system of claim 1, wherein obtaining the vegetation image data associated with the geographic region includes obtaining satellite imagery data of the geographic region, including near infrared light data.

3. The system of claim 2, wherein generating the vegetation index data points using the obtained vegetation image data includes generating Normalized Difference Vegetation Index (NDVI) data points.

4. The system of claim 1, wherein generating vegetation index data points using the obtained vegetation image data includes:
identifying a set of coordinates for which obtained vegetation image data exists, wherein the identified set of coordinates are within a threshold of the obtained target coordinates;
calculating vegetation index data points associated with the set of coordinates using the obtained vegetation image data, wherein vegetation index data points are calculated for each coordinate in the set of coordinates over a time period; and
generating average vegetation index data points using the calculated vegetation index data points associated with the set of coordinates; and
wherein plotting the signature curve associated with the geographic region using the generated vegetation index data points includes plotting the signature curve using the generated average vegetation index data points.

5. The system of claim 1, wherein classifying vegetation in the geographic region as a forest using the plotted signature curve includes:
providing the plotted signature curve to a trained model as input;
generating a model query requesting classification of vegetation in the geographic region; and
generating, by the trained model, vegetation classification output in response to the generated model query.

6. The system of claim 1, wherein the memory and the computer program code are configured to further cause the processor to analyze the obtained vegetation image data using at least one of a cropland data layer (CDL) data set or a wildfire historical data set, wherein classifying the vegetation in the geographic region and causing the forest preservation action to be performed are based on analyzing the obtained vegetation image data.

7. The system of claim 1, wherein the forest preservation action includes at least one of the following: generating a notification indicating that a forest fire is in close proximity to the geographic region, scheduling periodic monitoring of boundaries of the forest in the geographic region, or generating a notification indicating significant change in the monitored boundaries of the forest in the geographic region.

8. A computerized method comprising:
obtaining vegetation data associated with a geographic region;
generating vegetation index data points using the obtained vegetation data;
plotting a signature curve associated with the geographic region using the generated vegetation index data points;
classifying vegetation in the geographic region using the plotted signature curve; and
causing a vegetation management action to be performed in association with the geographic region based on the classified vegetation.

9. The computerized method of claim 8, wherein obtaining the vegetation data associated with the geographic region includes obtaining satellite imagery data of the geographic region, including near infrared light data.

10. The computerized method of claim 9, wherein generating the vegetation index data points using the obtained vegetation data includes generating Normalized Difference Vegetation Index (NDVI) data points.

11. The computerized method of claim 8, wherein generating vegetation index data points using the obtained vegetation data includes:
identifying a set of coordinates for which obtained vegetation data exists, wherein the identified set of coordinates is representative of the geographic region;
calculating vegetation index data points associated with the set of coordinates using the obtained vegetation data, wherein vegetation index data points are calculated for each coordinate in the set of coordinates over a time period; and
generating average vegetation index data points using the calculated vegetation index data points associated with the set of coordinates; and
wherein plotting the signature curve associated with the geographic region using the generated vegetation index data points includes plotting the signature curve using the generated average vegetation index data points.

12. The computerized method of claim 8, wherein classifying vegetation in the geographic region using the plotted signature curve includes:
providing the plotted signature curve to a trained model as input;
generating a model query requesting classification of vegetation in the geographic region; and
generating, by the trained model, vegetation classification output in response to the generated model query.

13. The computerized method of claim 8, further comprising analyzing the obtained vegetation data using at least one of a cropland data layer (CDL) data set or a wildfire historical data set, wherein classifying the vegetation in the geographic region and causing the vegetation management action to be performed are based on analyzing the obtained vegetation data.

14. The computerized method of claim 8, wherein the vegetation management action includes at least one of the following: generating a notification indicating that a forest fire is in close proximity to the geographic region, triggering a crop watering operation to be performed in the geographic region, triggering a crop fertilizing operation to be performed in the geographic region, or displaying a graphical user interface (GUI) of the geographic region including an indication of a vegetation type within the geographic region.

15. A computer storage medium has computer-executable instructions that, upon execution by a processor, cause the processor to at least:
obtain vegetation data associated with a geographic region, wherein the vegetation data includes satellite imagery data of the geographic region, including near infrared light data;
generate vegetation index data points using the obtained vegetation data;
plot a signature curve associated with the geographic region using the generated vegetation index data points;
compare the plotted signature curve to ground truth signature curves;
classify vegetation in the geographic region based on the comparison of the plotted signature curve to the ground truth signature curves; and
cause a vegetation management action to be performed in association with the geographic region based on the classified vegetation.

16. The computer storage medium of claim 15, wherein generating the vegetation index data points using the obtained vegetation data includes generating Normalized Difference Vegetation Index (NDVI) data points.

17. The computer storage medium of claim 15, wherein generating vegetation index data points using the obtained vegetation data includes:
identifying a set of coordinates for which obtained vegetation data exists, wherein the identified set of coordinates is representative of the geographic region;
calculating vegetation index data points associated with the set of coordinates using the obtained vegetation data, wherein vegetation index data points are calculated for each coordinate in the set of coordinates over a time period; and
generating average vegetation index data points using the calculated vegetation index data points associated with the set of coordinates; and
wherein plotting the signature curve associated with the geographic region using the generated vegetation index data points includes plotting the signature curve using the generated average vegetation index data points.

18. The computer storage medium of claim 15, wherein classifying vegetation in the geographic region using the plotted signature curve includes:
providing the plotted signature curve to a trained model as input;
generating a model query requesting classification of vegetation in the geographic region; and
generating, by the trained model, vegetation classification output in response to the generated model query.

19. The computer storage medium of claim 15, wherein the computer-executable instructions, upon execution by the processor, cause the processor to at least analyze the obtained vegetation data using at least one of a cropland data layer (CDL) data set or a wildfire historical data set, wherein classifying the vegetation in the geographic region and causing the vegetation management action to be performed are based on analyzing the obtained vegetation data.

20. The computer storage medium of claim 15, wherein the vegetation management action includes at least one of the following: generating a notification indicating that a forest fire is in close proximity to the geographic region, triggering a crop watering operation to be performed in the geographic region, triggering a crop fertilizing operation to be performed in the geographic region, or displaying a graphical user interface (GUI) of the geographic region including an indication of a vegetation type within the geographic region.
